(19) United States
(12) Patent Application Publication
(10) Pub. No.: US 2010/0159990 A1
(43) Pub. Date: Jun. 24, 2010

(54) CELLULAR BASESTATION

(75) Inventor: Justin Johnstone, Wiltshire (GB)

Correspondence Address: Weaver Austin Villeneuve & Sampson LLP, P.O. BOX 70250, OAKLAND, CA, 94612-0250, US

(73) Assignee: UBIQUISYS LIMITED, Wiltshire (GB)

(21) Appl. No.: 12/504,587

(22) Filed: Jul. 16, 2009

(30) Foreign Application Priority Data
Dec. 18, 2008 (GB) 0823142.5

(51) Int. Cl. H04B 1/38; H04M 1/00

(52) U.S. Cl. 455/561; 455/550.1

(57) ABSTRACT

A basestation, for a cellular communication network, is described. The basestation is adapted to store a list of user equipments that are authorized to access the network by means of the basestation. In the event that the basestation receives a location update request from an unauthorized user equipment, the basestation is adapted to send a reject message to the unauthorized user equipment. The reject message specifically identifies the basestation, such that the unauthorized user equipment does not attempt to send any further location update request to the basestation.

This invention relates to a cellular basestation, and in particular to a femtocell basestation, that is, a basestation that can be very widely deployed within the premises of customers, for example in homes or in small business properties, as part of a cellular communications network.

It is envisaged that two properties of a femtocell network may lead to particular problems if unresolved. The first issue is that, although each femtocell basestation will form a part of the cellular network, typically only a small number of user equipments (mobile phones or other wireless communications devices) will be allowed to access the network through that femtocell basestation. That is, only devices belonging to the customer on whose premises the femtocell basestation is located, or specifically authorized by that customer, will be allowed to access the network through the femtocell basestation. A mechanism is therefore required to prevent other user equipments from accessing the network.

The second issue is that a large number of deployed femtocell basestations may be forced to share a much smaller number of location area codes (LACs).

These issues interact, for example in the case of a femtocell basestation operating under the 3 GPP standards, in that the existing standards define the mechanisms whereby a femtocell can reject a connection request made by an unauthorized user equipment. More specifically, 3 GPP TS 24.008 (version 8.2.0 2008-06-06) section 4.4.4.7 indicates that, if the network is unable to accept a location updating request from a user equipment, for example because the user equipment is requesting access to a basestation on which it is not authorized, a LOCATION UPDATING REJECT message is sent from the basestation, specifying a reject cause. In response to the LOCATION UPDATING REJECT message, the user equipment acts in accordance with the specified reject cause.

However, it has now been determined that the reject causes that have been defined could lead to problems in the event that femtocells are widely deployed. For example, if a user equipment is rejected with a reject cause that forces it to back off from the registration request, but allows it to repeat the registration request after a time period has elapsed, there is a danger that the user equipment will simply make another registration request to the same femtocell basestation, and receive the same rejection. This is inefficient, both from the point of view of the basestation, and from the point of view of the user equipment.

As an alternative to this, the user equipment could be rejected with a reject cause that forces it to place the location area code of the femtocell basestation into a list of forbidden location area codes, such that it will not attempt any further registration requests to basestations having that location area code. This leads to the risk that, because of the possibility that a small number of location area codes may need to be shared amongst a large number of femtocell basestations, the location area code of that femtocell may be the same as the location area code of the user's own home femtocell basestation, with the result that the user would be locked out from his own home femtocell basestation.

According to a first aspect of the present invention, there is provided a basestation, for a cellular communication network, the basestation being adapted to store a list of user equipments that are authorized to access the network by means of the basestation, wherein, in the event that the basestation receives a location update request from an unauthorized user equipment, the basestation is adapted to send a reject message to said unauthorized user equipment, the reject message specifically identifying the basestation, such that the unauthorized user equipment does not attempt to send any further location update request to the basestation.

According to a second aspect of the present invention, there is provided a user equipment, for use in a cellular communications network, the user equipment being adapted, in response to a reject message containing a predetermined reject cause, to store an identity of a cell from which the reject message was received and the user equipment being further adapted, in the event that a location update to a cell is indicated, and the cell to which the location update is indicated is the cell whose identity was stored, not to request a location update to said cell.

According to a third aspect of the present invention, there is provided a method of controlling access to a basestation of a cellular communication network, the method comprising:
storing in the basestation a list of user equipments that are authorized to access the network by means of the basestation,
receiving in the basestation a location update request from an unauthorized user equipment,
sending from the basestation to said unauthorized user equipment a predetermined reject message, the predetermined reject message specifically identifying the basestation such that the unauthorized user equipment does not attempt to send any further location update request to the basestation.

According to a fourth aspect of the present invention, there is provided a method of controlling access to a basestation of a cellular communication network, the method comprising:
receiving from the basestation a predetermined reject message specifically identifying the basestation,
storing in the unauthorized user equipment the identity of the basestation, and
not sending further location update requests to the basestation.

This has the advantage that an attempt by an unauthorized user equipment to perform a location update to a cell can be rejected efficiently, while avoiding a problem that the user equipment may be made unable to perform a location update to a cell in which it is properly authorized.

For a better understanding of the present invention, and to show how it may be put into effect, reference will now be made, by way of example, to the accompanying drawings, in which:

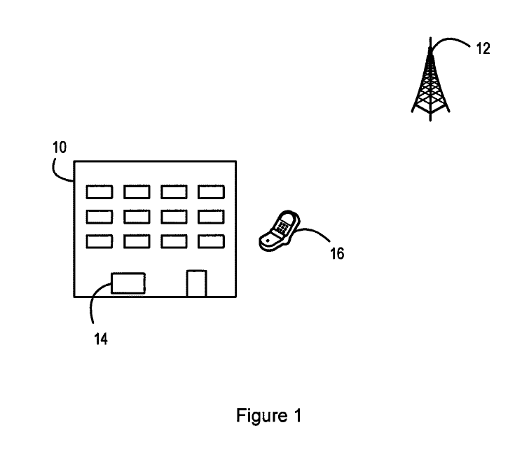

FIG. 1 is a schematic diagram illustrating a part of a cellular communications network in accordance with an aspect of the present invention.

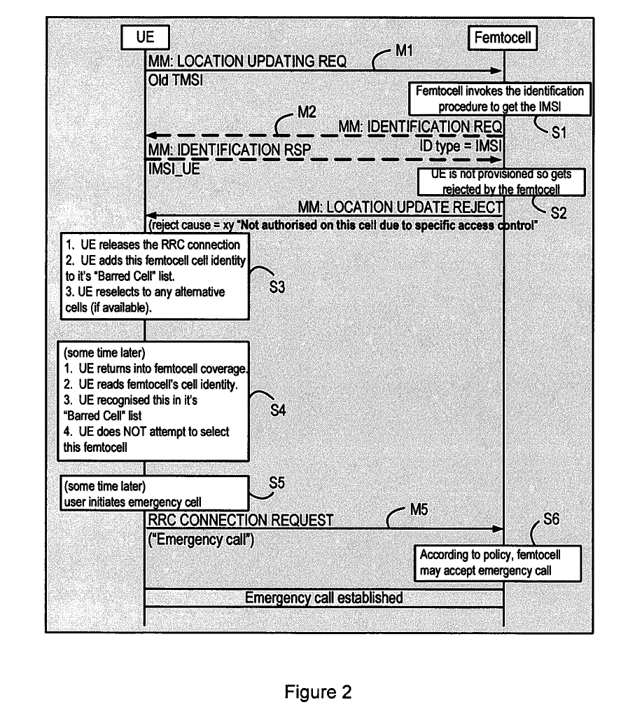

FIG. 2 illustrates signalling in accordance with an aspect of the present invention.

FIG. 1 shows a part of a cellular communication network. Specifically, FIG. 1 shows a customer premises 10, which may be domestic property, or a business premises, located within the coverage area of a macrocell basestation 12 that forms part of a cellular wireless communications network. Located within the premises 10 there is positioned a femtocell basestation 14. As is known, the femtocell basestation comprises RF interface circuitry, for communicating over a cellular interface with authorized user equipments within its coverage area, and also includes an interface for communicating with the core network of the cellular network, for example over a broadband internet connection to the customer premises. The operation of the femtocell basestation is controlled by a processor, which runs suitable software for performing the relevant control processes. The femtocell basestation has a restricted number of user equipments which are permitted to receive service. These user equipments will typically be the user equipments owned by the customer, or may be other user equipments specifically authorized by the customer.

The invention relates to the operation of the femtocell basestation 14, in particular in the circumstance where an unauthorized user equipment, such as the mobile phone 16 shown in FIG. 1, attempts to access the femtocell. As is conventional, the user equipment comprises RF interface circuitry, for communicating over a cellular interface with a basestation such as the femtocell basestation 14, and also includes a user interface that may also be conventional, for example with a keypad, a display, a speaker and a microphone. The operation of the user equipment is controlled by a processor, which runs suitable software for performing the relevant control processes.

Although the invention is described with reference to its use in a femtocell, it will be appreciated that the same procedure can be performed in any basestation of a network.

FIG. 2 shows the message flow between the user equipment (UE) 16 and the femtocell basestation 14 in this situation.

The process begins when the UE, camped on the macrocell basestation 12, decides to camp on the femtocell, for example because it has moved near enough to, or inside, the premises 10 that it is receiving a stronger signal from the femtocell basestation 14 than the macrocell basestation 12. Reading the system information broadcast by the femtocell basestation 14, it detects a different Location Area Identity (LAI) from that broadcast by the cell where it is currently camped. This triggers the UE 16 to perform a Location Updating procedure towards the femtocell.

As is required by the existing 3GPP standard, the UE sends message M1, a Location Updating Request message, to the femtocell. This message includes an identity of the UE, which typically takes the form of a TMSI (Temporary Mobile Subscriber Identity). On receipt of the Location Updating Request message containing the TMSI, the femtocell initiates the MM Identification procedure, which is usually required to obtain the identity of the UE in the form of the IMSI (International Mobile Subscriber Identity), since this is typically required by the femtocell as the basis upon which to apply access control.

Thus, the femtocell basestation 14 sends the Identification Request message M2 to the UE 16, which responds with the Identification Response message M3 containing the IMSI of the UE.

In step S2, the femtocell basestation 14 performs access control using the received IMSI from the UE. If, as in this case, the femtocell basestation 14 determines from the identity of the UE that the UE is not authorised to access that femtocell (typically because the IMSI is not in a list of specifically authorised UEs), then the femtocell rejects the UE by sending a Location Update Reject message M4.

As described so far, the behaviour of the UE and the femtocell basestation is as described in existing versions of the 3GPP standard.

In this case, the Location Update Reject message M4 sent by the femtocell basestation 14 contains the reject cause “Not authorised on this cell due to specific access control”, or the like, and the UE receives this reject message.

In response to the reject message with the reject cause “Not authorised on this cell due to specific access control”, the UE performs step S3, that is, it releases the RRC connection, adds the cell identity of the femtocell to a list of barred cells, and reselects to an alternative cell, if available. As described below, the UE is then generally not permitted to select or reselect this cell, although an exception may exist for emergency calls, and the UE is not permitted to receive any MBMS services on this cell.

The UE therefore maintains a list of “barred cells” and, when it receives a reject message with the reject cause “Not authorised on this cell due to specific access control”, the UE adds the cell identity of this femtocell into the list. If the list has a maximum size, and is full when the UE attempts to add the cell identity of this femtocell into the list, the earliest entry is removed and the new femtocell identity is added as the most recent entry. The UE may for example delete the list of “barred cells” when the UE is turned off and/or the (U)SIM is removed from the UE.

The effect of this behaviour is now described with reference to the situation where the UE 16 roams back into the area of the femtocell 14, at a time when the cell still appears in the list of “barred cells” maintained by the UE. Specifically, the UE performs step S4. That is, when it roams into the coverage area of the femtocell 14, and determines that its signal strength may make it appropriate to change cell to the femtocell 14, the UE decodes the system information broadcast by the femtocell and sees the femtocell cell identity is in its list of “barred cells”. Having made this determination, the UE does not perform a location update onto the femtocell.

Step S5 relates to a further aspect of the behaviour of the UE 16, specifically in the situation where the user initiates an emergency call towards the femtocell. More specifically, step S5 identifies one possible scenario, where the UE is not able to register onto any other macrocell (or any other femtocell), and therefore only has coverage from the femtocell basestation 14, which is barred as a result of the access control rejection mechanism described above.

In this case, the UE remains out of service and cannot make or receive normal calls, or text messages, or enjoy other network services.

However, if the user of the UE initiates an emergency call, then the UE is allowed to override the barred status of the femtocell and proceed to make the emergency call on this barred femtocell.

Thus, this contrasts with existing macrocell cell barring concepts, in which the macrocell repeatedly signals its “barred” status on broadcast channels that all UEs read when under coverage of that macrocell, and in which, if the UE detects coverage from this macrocell only and not from other suitable cells, the UE remains out of normal service, and will not attempt to make an emergency call on this barred macrocell if the user initiates an emergency call. Rather, as shown in step S5, although a UE considers the femtocell as barred for access control as a result of the dedicated access control signalling procedure using reject cause “Not authorised on this cell due to specific access control”, or the like, if the UE only detects coverage from this femtocell and from no other suitable cells, then the UE remains out of normal service, but, if the user initiates an emergency call, the UE will attempt to make an emergency call on this barred femtocell.

Specifically, as shown in FIG. 2, the UE 16 sends a message M5 to the femtocell basestation, in the form of an RRC connection request, indicating that it is making an emergency call.

Based on policy the femtocell may then accept the request as shown in step S6, and allows the emergency call to proceed, even though the UE is not one that appears on its list of permitted UEs. For example, the policy may be that the femtocell will accept all requests for emergency calls. Meanwhile, other UEs that are registered on the femtocell are still provided normal service on the femtocell. Thus, the barring is only applicable to the specific UE based on access control.

Thus, the femtocell capacity and resources are not significantly negatively impacted by unprovisioned users, and the femtocell resources are better dedicated to serve provisioned users and therefore provide improved capacity to deliver services to those users. Further, users do not get barred from accessing their home cell. This means that they are able to continue accessing services, and do not cause the operator to incur support costs (for example in a customer services department) to resolve scenarios where the user is blocked from accessing their home femtocell. Moreover, unprovisioned users to not suffer the battery drain that would occur in making repeated unsuccessful attempts to camp on a visited femtocell, and are not barred from accessing their home femtocell.

1. A basestation, for a cellular communication network, the basestation being adapted to store a list of user equipments that are authorized to access the network by means of the basestation, wherein, in the event that the basestation receives a location update request from an unauthorized user equipment, the basestation is adapted to send a reject message to said unauthorized user equipment, the reject message specifically identifying the basestation, such that the unauthorized user equipment does not attempt to send any further location update request to the basestation.

2. A basestation as claimed in claim 1, the basestation being further adapted, in the event that it receives a request for an emergency call from said unauthorized user equipment to which said reject message was sent, to accept said request for an emergency call.

3. A user equipment, for use in a cellular communications network, the user equipment being adapted, in response to a reject message containing a predetermined reject cause, to store an identity of a cell from which the reject message was received and the user equipment being further adapted, in the event that a location update to a cell is indicated, and the cell to which the location update is indicated is the cell whose identity was stored, not to request a location update to said cell.

4. A user equipment as claimed in claim 3, wherein the user equipment is adapted to store a list of cells from which said reject message has been received.

5. A user equipment as claimed in claim 4, wherein the user equipment is further adapted, in the event that it receives a reject message containing said predetermined reject cause, and the stored list of cells contains a predetermined maximum number of cells, to discard one of said cells from said stored list of cells.

6. A user equipment as claimed in claim 3, wherein the user equipment is further adapted, in the event that the user equipment detects coverage only from the cell from which the reject message was received, and a user of the user equipment initiates an emergency call, to attempt to make an emergency call on said cell.

7. A method of controlling access to a basestation of a cellular communication network, the method comprising:
storing in the basestation a list of user equipments that are authorized to access the network by means of the basestation,
receiving in the basestation a location update request from an unauthorized user equipment,
sending from the basestation to said unauthorized user equipment a predetermined reject message, the predetermined reject message specifically identifying the basestation such that the unauthorized user equipment does not attempt to send any further location update request to the basestation.

8. A method as claimed in claim 7, further comprising: in the event that the basestation receives a request for an emergency call from said unauthorized user equipment to which said reject message was sent, accepting said request for an emergency call.

9. A method of operation of a user equipment in a cellular communication network, the method comprising:
receiving from the basestation a predetermined reject message specifically identifying the basestation,
storing in the unauthorized user equipment the identity of the basestation, and
not sending further location update requests to the basestation.

10. A method as claimed in claim 9, further comprising:
storing a list of cells from which said reject message has been received.

11. A method as claimed in claim 10, further comprising:
in the event that the user equipment receives a reject message containing said predetermined reject cause, and the stored list of cells contains a predetermined maximum number of cells, discarding one of said cells from said stored list of cells.

12. A method as claimed in claim 9, further comprising:
in the event that the user equipment detects coverage only from the cell from which the reject message was received, and a user of the user equipment initiates an emergency call, attempting to make an emergency call on said cell.
